(19) United States
(12) Patent Application Publication
(10) Pub. No.: US 2025/0328975 A1
(43) Pub. Date: Oct. 23, 2025

(54) AGREEMENT DETERMINATION DEVICE, AGREEMENT DETERMINATION METHOD, AND STORAGE MEDIUM

(71) Applicant: NEC Corporation, Tokyo (JP)

(72) Inventor: Tomohito ANDO, Tokyo (JP)

(73) Assignee: NEC Corporation, Tokyo (JP)

(21) Appl. No.: 19/171,656

(22) Filed: Apr. 7, 2025

(30) Foreign Application Priority Data
Apr. 18, 2024 (JP) 2024-067362

(51) Int. Cl. G06Q 50/18

(52) U.S. Cl. CPC G06Q 50/188

(57) ABSTRACT

The agreement determination device 1X mainly includes a proposal acquisition means 30X, a proposal notification means 31X, and an agreement determination means 33X. The proposal acquisition means 30X acquires a divisible proposal provided by a first negotiator. The proposal notification means 31X notifies a second negotiator, which conducts negotiations with the first negotiator, of the proposal. The agreement determination means 33X determines whether or not the second negotiator makes a partial agreement on the proposal.

### INCORPORATION BY REFERENCE

This application is based upon and claims the benefit of priority from Japanese Patent Application No. 2024-067362, filed on Apr. 18, 2024, the disclosure of which is incorporated herein in its entirety by reference.

### TECHNICAL FIELD

The present disclosure relates to a technical field of an agreement determination device, an agreement determination method, and a storage medium.

### BACKGROUND

A system is known in which automatic negotiations on the condition adjustment between an orderer and a contractor is performed. For example, Patent Literature 1 discloses an automatic negotiation system configured to previously store proposals for negotiations according to possible orders from the orderer and then preferentially select a proposal having the largest utility with respect to the terms and conditions of negotiations received from the orderer to transmit the selected proposal to the orderer.

### CITATION LIST

### Patent Literature

Patent Literature 1: WO2021/024414

### SUMMARY

In general, if there are unacceptable points in the offer supplied from the counterpart, the offer will not be agreed. Once the negotiations have broken down, the next negotiations will be substantially started all over again from the state prior to the negotiations.

In view of the above-described issues, one object of the present disclosure is to provide an agreement determination device, an agreement determination method, and a storage medium capable of suitably reducing the burden of the next negotiations.

In an example aspect of the present disclosure, there is provided an agreement determination device including:
a proposal acquisition means configured to acquire a divisible proposal provided by a first negotiator;
a proposal notification means configured to notify a second negotiator, which conducts negotiations with the first negotiator, of the proposal; and
an agreement determination means configured to determine whether or not the second negotiator makes a partial agreement on the proposal.

In an example aspect of the present disclosure, there is provided an agreement determination method executed by a computer, including:
acquiring a divisible proposal provided by a first negotiator;
notifying a second negotiator, which conducts negotiations with the first negotiator, of the proposal; and
determining whether or not the second negotiator makes a partial agreement on the proposal.

In an example aspect of the present disclosure, there is provided a program executed by a computer, the program causing the computer to:
acquire a divisible proposal provided by a first negotiator;
notify a second negotiator, which conducts negotiations with the first negotiator, of the proposal; and
determine whether or not the second negotiator makes a partial agreement on the proposal.

An example advantage according to the present disclosure is to suitably reduce the burden of the next negotiations.

### BRIEF DESCRIPTION OF THE DRAWINGS

FIG. 1 illustrates a configuration of the negotiation system.

FIG. 2 illustrates the hardware configuration of the platform providing device.

FIG. 3 illustrates the hardware configuration of the terminal device.

FIG. 4 illustrates an example of functional blocks in the negotiation platform.

FIG. 5 illustrates an example of an offer edit screen image before input from a negotiator.

FIG. 6 illustrates an example of an offer edit screen image after the input from the negotiator.

FIG. 7 illustrates an example of an offer edit screen image after a fold button has been selected.

FIG. 8 illustrates a negotiation result screen image displayed once the negotiation suspend button has been selected.

FIG. 9 is an example of a flowchart executed by a platform providing device.

FIG. 10 illustrates the configuration of the negotiation system.

FIG. 11 illustrates functional blocks of an agreement determination device.

FIG. 12 illustrates an example of a flowchart showing a processing procedure of the agreement determination device.

### EXAMPLE EMBODIMENTS

Hereinafter, example embodiments of an agreement determination device, an agreement determination method, and a storage medium will be described with reference to the drawings.

In the following explanation, the term “negotiation” refers to an adjustment of terms and conditions until the conclusion of an agreement between a party that places an order and a party that receives an order. In this example embodiment, the term “negotiations” mainly indicates actions taken by the parties to alternatively offer and counteroffer a proposal (also referred to as “offer”) for the agreement on the terms and conditions of the order. The negotiations in this case may be negotiations between parties with conflicting interest or may be negotiations (so-called adjustment) between parties without conflicting interest. Negotiations also include not only negotiations on general orders in which purchase orders are issued, but also adjustments to expected delivery quantities, etc., without issuing purchase orders. Also, examples of target terms and conditions (so-called issue) of negotiations include prices of products, due dates, quantities, means of transportation, resources (airspace if a drone is used as means of transportation), functions, and qualities. The term “negotiator” also refers to a subject that is responsible for placing an order and receiving an order, and has, for example, the ability to provide a proposal for agreement to the other negotiator, and the ability to determine whether or not to agree on the offer supplied from the other negotiator. The negotiator may be an individual or may be an organization. The negotiator may negotiate using an AI, a robotics, or any other device (including a drone and an autonomous vehicle) to reflect the intention of the individual or organization.

### First Example Embodiment

### (1) System Configuration

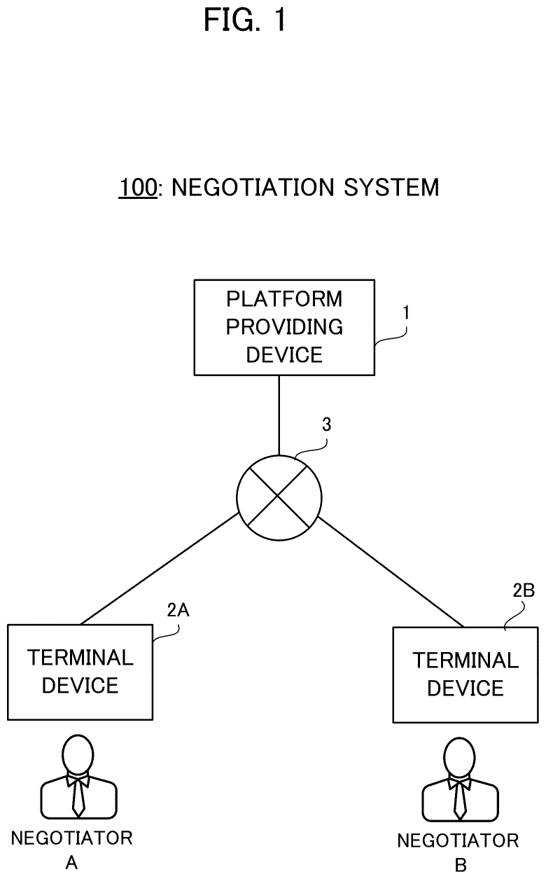

FIG. 1 illustrates the configuration of a negotiation system 100. The negotiation system 100 mainly includes a platform providing device 1 that provides an electronic negotiation platform for negotiating terms and conditions, and a terminal device 2A and a terminal device 2B that are used by negotiators that conduct negotiations on the negotiation platform provided by the platform providing device 1. The platform providing device 1, the terminal device 2A, and the terminal device 2B perform data communication via the network 3 with one another. In FIG. 1, as an example, a terminal device 2A usable by the negotiator A, and a terminal device 2B usable by the negotiator B is illustrated, and hereafter, when the terminal device 2A and the terminal device 2B are not particularly distinguished, these are simply referred to as “terminal device 2”.

Hereinafter, the negotiations between the negotiator A and the negotiator B on a one-to-one basis will be described as an example. It is noted that negotiations with competitive quotes, total amount negotiations, nested negotiations may be performed by combining a plurality of one-to-one basis negotiations to be described below.

The platform providing device 1 provides a negotiation platform required for negotiations on the terms and conditions between the negotiator A and the negotiator B through the terminal device 2A and the terminal device 2B. For example, the negotiator who places an order is a manufacturer of products, and the negotiator who receives the order is a supplier who supplies components (parts) necessary for the manufacture of the products. The platform providing device 1 generates display information required for display of information required for negotiations, and transmits the generated display information to the terminal device 2A and the terminal device 2B to control the display of the terminal device 2A and the terminal device 2B. In this instance, the platform providing device 1 receives the input information related to the offer from the terminal device 2A and the terminal device 2B and generates the above-described display information based on the received input information. The platform providing device 1 is an example of the “agreement determination device”.

The terminal device 2 (2A, 2B) are communication devices used by the negotiators, and, on the basis of the data communication with the platform providing device, displays the information or accepts the input from the negotiators. In the present example embodiment, as an example, the negotiator A shall conduct automated negotiations through a negotiation AI (the description of the negotiation AI will be given later) in principle, and the negotiator B shall conduct negotiations (hereinafter, also referred to as “manual-based negotiations”) based on a manual input through the terminal device 2B without using any negotiation AI. It is noted that upon determining that the automated negotiations by the negotiation AI does not lead to an agreement, or upon determining, in other cases, that manual-based negotiations are required, the negotiator A can switch to the manual-based negotiations based on the input through the terminal device 2A.

The configuration of the negotiation system 100 shown in FIG. 1 is an example, and various changes may be made to the configuration. For example, the platform providing device 1 may be configured by a plurality of devices. In this case, the plurality of devices constituting the platform providing device 1 performs transmission and reception of information necessary for executing the pre-allocated process among the plurality of devices.

### (2) Hardware Configuration

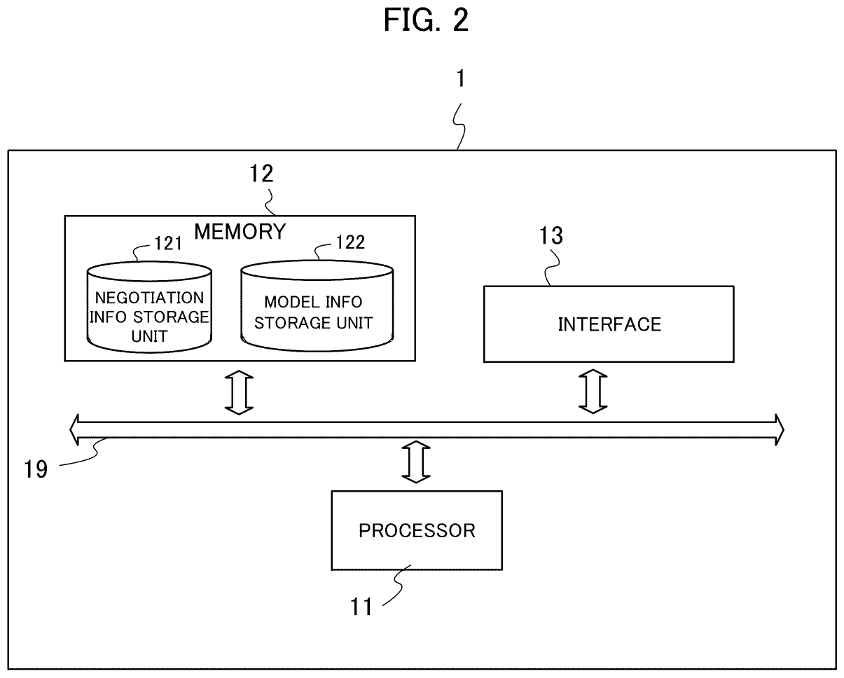

FIG. 2 shows the hardware configuration of the platform providing device 1. The platform providing device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer. The memory 12 is configured by various volatile memories and non-volatile memories

such as a RAM (Random Access Memory) and a ROM (Read Only Memory). The memory 12 further stores a program for executing various process by the platform providing device 1. The memory 12 is also used as a working memory.

The memory 12 functionally includes a negotiation information storage unit 121 and a model information storage unit 122.

The negotiation information storage unit 121 stores negotiation information which is information relating to the negotiations between the negotiator A and the negotiator B. The negotiation information includes information on an offer currently-agreed between negotiator A and negotiator B.

In this example embodiment, an offer is separable. For example, order numbers are assigned to products subject to order according to the types of the products, and one offer indicates a proposal (draft) of terms and conditions relating to plural order numbers.

The model information storage unit 122 stores model information (including parameters) for configuring a negotiation AI which is an artificial intelligence model for negotiating with the other negotiator as an agent for the negotiator. The negotiation AI is utilized for negotiating with the other negotiator (here, negotiator B) by the negotiator A which is an individual or an organization.

The negotiation AI include an acceptance strategic function that makes a determination (so-called acceptance determination) as to whether or not to make an agreement (including partial agreement) on an offer provided by the other negotiator, and an offer generation function that generates an offer. Examples of the offer generation include the generation of an alternative offer (also referred to as “counteroffer”) upon determining that the offer provided by the other negotiator cannot be agreed upon. Any technique may be used to generate an offer, such as beam search, grid search, search by probabilistic optimization such as a genetic algorithm, search by Bayesian optimization, and a combination thereof. In some embodiments, the negotiation AI may calculate the utility using the utility function for calculating the degree of goodness of the offer, and then, based on the utility, makes the acceptance determination as to the offer supplied from the other negotiator and determines an offer to provide with the other negotiator. For example, the negotiation AI may decide to accept an offer whose utility is greater than or equal to a predetermined threshold value, and may decide not to accept an offer whose utility is less than the above-mentioned threshold value. The negotiation AI may also make plural options for an offer to notify the other negotiator, and selects the option having the highest utility as the offer. It is noted that a method of determining an offer based on a utility function is disclosed in, for example, Patent Literature 1.

The interface 13 is one or more interfaces for electrically connecting the platform providing device 1 to other devices. Examples of the interfaces include a wireless interface, such as network adapters, for transmitting and receiving data to and from other devices wirelessly, and a hardware interface, such as a cable, for connecting to other devices.

The hardware configuration of the platform providing device 1 is not limited to the configuration shown in FIG. 2. For example, the platform providing device 1 may include at least one of an input device, a display device, and/or a sound output device. At least a part of the information stored in the memory 12 may be stored in one or more storage devices other than the platform providing device 1. In this case, examples of the storage devices include a hard disk connected to the platform providing device 1, a storage medium such as a flash memory, and a server device that performs data communication with the platform providing device 1.

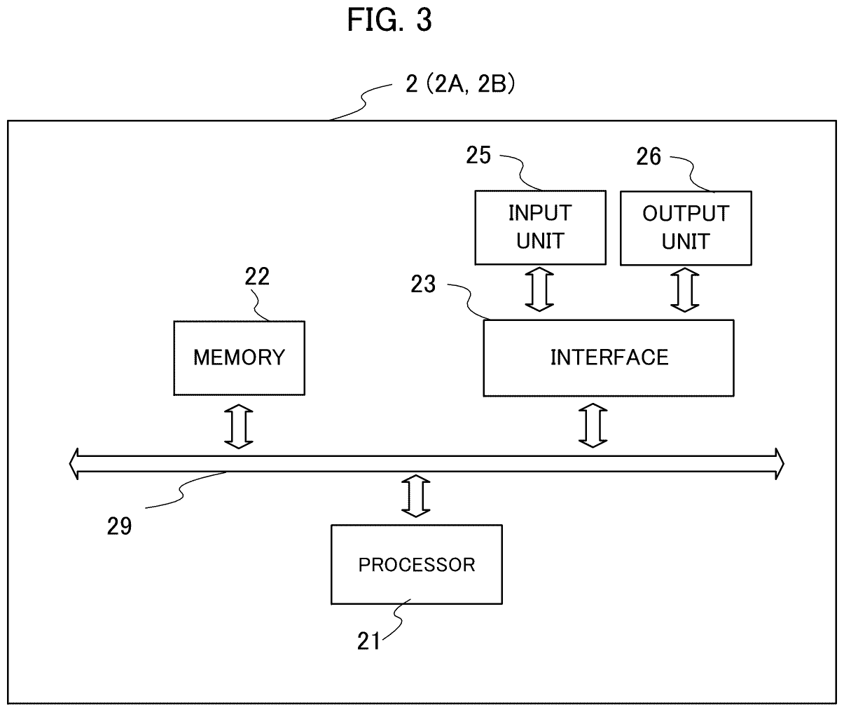

FIG. 3 shows the hardware configuration of the terminal device 2, that is, the hardware configuration common to the terminal device 2A and the terminal device 2B. The terminal device 2 includes a processor 21, a memory 22, and an interface 23 as hardware. The processor 21, memory 22, and interface 23 are connected to one another via a data bus 29.

The processor 21 executes a predetermined process by executing a program stored in the memory 22. Examples of the processor 21 is a processor such as a CPU, a GPU, and a TPU. The processor 21 may be configured by a plurality of processors. The processor 21 is an example of a computer.

The memory 22 is configured by various volatile memories and non-volatile memories such as a RAM (Random Access Memory) and a ROM (Read Only Memory). Further, in the memory 22, a program for executing various processes by the platform providing device 1 is stored. The memory 22 is also used as a working memory.

The interface 23 is one or more interfaces for electrically connecting the terminal device 2 to other devices. Examples of the interfaces include a wireless interface, such as a network adapter, for transmitting and receiving data to and from other devices wirelessly, and a hardware interface, such as a cable, for connecting to other devices.

The interface 23 performs the interface operation of the input unit 25 and the output unit 26. The input unit 25 is a user interface that receives an input that is an external input, and examples of the input unit 25 include a touch panel, a button, a keyboard, and a voice input device. The interface 23 supplies the input signal generated by the input unit 25 to other components in the terminal device 2 or a device existing outside the platform providing device 1. The output unit 26 performs display or audio output of predetermined information based on the output signal supplied through the interface 23. Examples of the output unit 26 include a display, a projector, and an audio output device.

The hardware configuration of the terminal device 2 is not limited to the configuration shown in FIG. 3. For example, at least one of the input unit 25 and/or the output unit 26 may be configured separately from the terminal device 2.

### (3) Negotiation Platform Process

Next, a description will be given of the process related to the negotiation platform realized by the platform providing device 1. In summary, the platform providing device 1 provides a negotiation platform such that, if only a part of the offer can be acceptable for a negotiator, the negotiator can agree on the part (i.e., make a partial agreement). This allows for suitable reduction of the burden of the next negotiations even if the negotiations are suspended for some reasons such as switching from the automated negotiations by the negotiation AI to the manual-based negotiations. Hereafter, each part of an offer, when the offer is divided into units on which partial agreement is possible, is also referred to as “partial offer”.

Supplementary explanation is given herein on the advantages of the system in which a partial agreement can be made.

Negotiations such as a delivery time adjustment of parts that could occur on a daily-basis among manufacturers cannot be left as it is after the breakdown of the negotiations to avoid the risk of missing parts. Therefore, when the automated negotiations are broken down, it is necessary for the negotiator to take over the negotiations. On the other hand, as long as there is a non-agreed point that cannot reach a mutual agreement, the negotiations as a whole do not come to an agreement. If the agreement is not reached by automated negotiations, then it is often the case that the negotiator takes over the negotiations and performs manual-based negotiations.

Unfortunately, in this case, since it cannot be said that there has been progress in the automated negotiations, the negotiator will substantially start the manual-based negotiations all over again from the state prior to the automated negotiations.

In view of the above, the platform providing device 1 in the present example embodiment provides a negotiation platform in which a partial agreement is available. In this way, when a person takes over the negotiations, the person can start the negotiations from the state where the negotiations are advanced, thus reducing the burden of negotiations. For example, in the case of automated negotiations made for the delivery date of products, even if the automated negotiations are finished in a state where an agreement cannot be made in terms of the delivery date of the product in the future order, the next negotiations can get started in the state where a partial agreement is made by the automated negotiations in terms of the delivery date in the upcoming order. Thus, since the person in charge of negotiations taking over the automated negotiation only has to negotiate the part (future order) unagreed in the automated negotiation, the burden of the negotiations is suitably reduced. In other words, by allowing the offer to be partially agreed upon in the negotiation platform in this example embodiment, compared to a conventional negotiation platform with only two choices of whether to agree on the entire offer or not, it is possible to reduce the burden of the person taking over the negotiations or the burden of the ongoing negotiations by the negotiation AI.

### (3-1) Functional Blocks

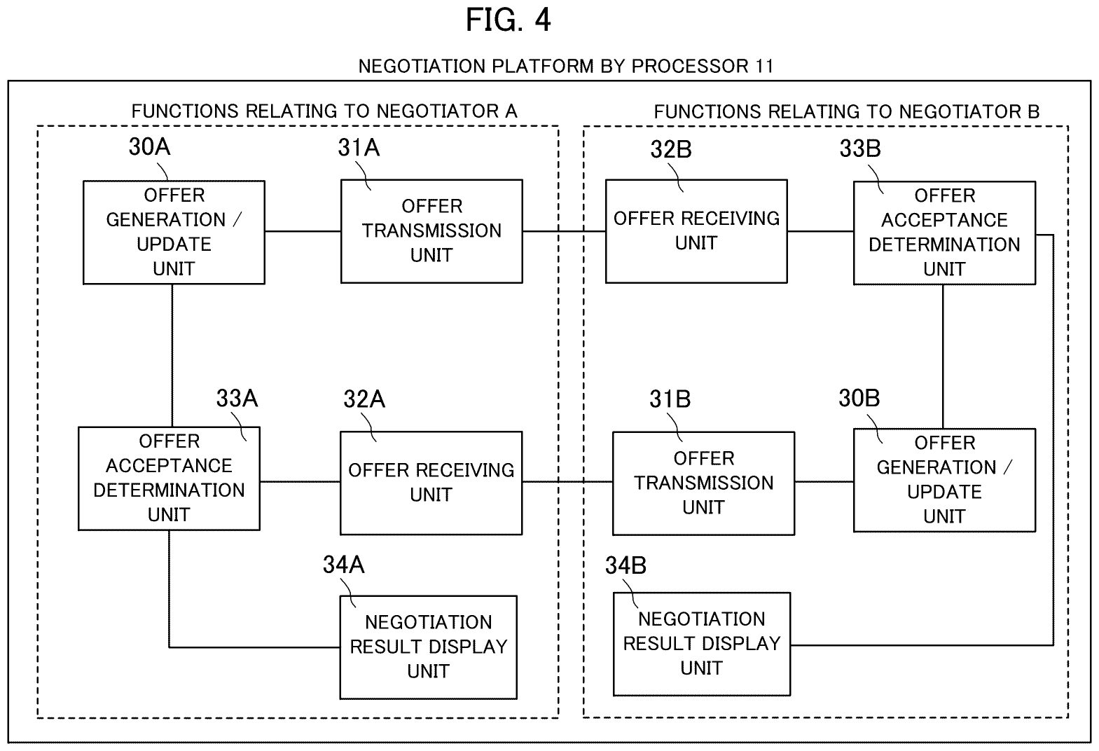

FIG. 4 is an example of a functional block in a negotiation platform implemented by the processor 11 of the platform providing device 1. The negotiation platform includes an offer generation/update unit 30A, an offer transmission unit 31A, an offer receiving unit 32A, an offer acceptance determination unit 33A, and a negotiation result display unit 34A as functions relating to the negotiator A. The negotiation platform includes an offer generation/update unit 30B, an offer transmission unit 31B, an offer receiving unit 32A, an offer acceptance determination unit 33B, and a negotiation result display unit 34B as functions relating to the negotiator B. In FIG. 4, blocks to exchange data with each other are connected by a solid line, but the combination of the blocks to exchange data with each other is not limited thereto. The same applies to the drawings of other functional blocks described below.

First, the functions relating to the negotiator A will be described.

The offer generation/update unit 30A generates and updates an offer by the negotiation AI. The term “updating an offer” refers to generating a counteroffer upon determining that an offer supplied from the negotiator B is unacceptable. In this case, for example, the processor 11 configures the negotiation AI referring to the model information stored in the model information storage unit 122 and executes the process related to the offer generation/update unit 30A. The negotiation AI generates an offer based on the negotiation information and the like stored in the negotiation information storage unit 121. Upon receiving, from the offer acceptance determination unit 33A, the latest offer and the determination result indicating the refusal of the offer, the negotiation AI updates the received offer. In this case, the negotiation AI generates a counteroffer which is different from the offer only in the unagreed part while being consistent with the offer in terms of the other agreed part. The offer generation/update unit 30A supplies the generated or updated offer to the offer transmission unit 31A.

The offer transmission unit 31A supplies information indicating the offer generated or updated by the offer generation/update unit 30A to the offer receiving unit 32B. For example, the processor 11 functions as an offer transmission unit 31A to generate display information for displaying the offer generated or updated by the offer generation/update unit 30A on the terminal device 2B. Then, the processor 11 transmits the generated display information to the terminal device 2B through the interface 13. When transmitting the information indicating the updated offer (i.e., the counteroffer), the offer transmission unit 31A may transmit information indicating both the agreed partial offer and the non-agreed partial offer, or may transmit only information indicating the non-agreed partial offer. The agreed partial offer is an example of the “agreed part of a proposal”, and the non-agreed partial offer is an example of the “non-agreed part of a proposal”.

The offer receiving unit 32A receives information indicating an offer supplied from the offer transmission unit 31B, which will be described later. In this case, for example, the processor 11 functions as an offer receiving unit 32A and receives information indicating an offer supplied from the offer transmission unit 31B. When the offer receiving unit 32A receives the information indicating the counteroffer, it may receive information indicating both the agreed partial offer and the non-agreed partial offer, or may receive information indicating only the non-agreed partial offer.

The offer acceptance determination unit 33A determines whether or not to accept (i.e., agree on) the offer which the offer receiving unit 32A has received. In this case, for example, the processor 11 configures the negotiation AI with reference to the model information stored in the model information storage unit 122 and executes the process related to the offer acceptance determination unit 33A. On the basis of information indicating the offer received by the offer receiving unit 32A, the negotiation AI determines whether or not to agree on each non-agreed partial offer.

Upon determining that there is an agreed partial offer, the offer acceptance determination unit 33A adds partial agreement information indicating the agreement of the agreed partial offer to the negotiation information stored in the negotiation information storage unit 121. The partial agreement information is, for example, flag information indicating that the partial offer has been agreed upon. Instead of generating and storing the partial agreement information, the offer acceptance determination unit 33A may store information indirectly indicating that the partial offer has been agreed on in the negotiation information storage unit 121. For example, the offer acceptance determination unit 33A may store the history of the terms and conditions proposed by the negotiator A and the negotiator B in the negotiation information storage unit 121 for each partial offer. Even in this case, by referring to the above-mentioned history, it is possible to identify that partial agreements have been made for partial offers regarding the terms and conditions agreed by both the negotiator A and negotiator B.

Upon determining that the entire offer (i.e., all of the partial offers) received by the offer receiving unit 32A is acceptable, the offer acceptance determination unit 33A supplies information (i.e., information indicating the offer received by the offer receiving unit 32A) indicating the agreed offer to the negotiation result display unit 34A. The offer acceptance determination unit 33A may also provide the negotiation result display unit 34B with information indicating the agreed offer.

Upon determining that the entire offer received by the offer receiving unit 32A is not acceptable and it is necessary to switch to the manual-based negotiations, the offer acceptance determination unit 33A supplies information indicating both the currently-agreed partial offers and currently-non-agreed partial offers to the negotiation result display unit 34A. The offer acceptance determination unit 33A may supply the above-described information to the negotiation result display unit 34B in the same manner. For example, the offer acceptance determination unit 33A needs to switch to manual-based negotiations upon determining the offer which the offer receiving unit 32A received at the last time has no change (i.e., the negotiations are not advanced) from the offer which the offer receiving unit 32A received at the last but one time. In another instance, upon receiving a request for the suspension of negotiations from the negotiator B, the offer acceptance determination unit 33A determines that the negotiations should be switched to manual-based negotiations.

On the other hand, upon determining that the offer received by the offer receiving unit 32A is not acceptable as a whole and that there is no need to switch to manual-based negotiations, the offer receiving unit 33A supplies the determination result for each partial offer to the offer generation/update unit 30A. The determination result indicating that the offer cannot be accepted may include information indicating both the agreed partial offers and the non-agreed partial offers, or may include information indicating the non-agreed partial offers. The offer acceptance determination unit 33A determines that there is no need to switch to manual-based negotiations upon determining the offer which the offer receiving unit 32A received at the last time has changed from the offer which the offer receiving unit 32A received at the last but one time.

In another example, the offer acceptance determination unit 33A determines that it is not necessary to switch to manual-based negotiations if there is no request for suspension of negotiations from the negotiator B.

The negotiation result display unit 34A displays on the terminal device 2A the negotiation result based on the information received from the offer acceptance determination unit 33A. In this instance, the processor 11 functions as the negotiation result display unit 34A to generate display information based on the information received from the offer acceptance determination unit 33A and supplies the generated display information to the terminal device 2A. For example, if the offer is agreed as a whole, the negotiation result display unit 34A displays on the terminal device 2A the information on the agreed offer based on the information received from the offer acceptance determination unit 33A. On the other hand, if the offer is not agreed as a whole, the negotiation result display unit 34A displays the information on both the currently-agreed partial offers and the currently-non-agreed partial offers on the terminal device 2A. Once the offer acceptance determination unit 33B determines that the negotiations should be suspended, the negotiation result display unit 34A may display the negotiation result based on the information received from the offer acceptance determination unit 33B or the like on the terminal device 2A. Next, a description will be given of the functions relating to the negotiator B.

The offer receiving unit 32B receives information indicating the offer supplied from the offer transmission unit 31A. In this case, for example, the terminal device 2B functions as an offer receiving unit 32B under the control of the processor 11, and receives information indicating an offer supplied from the offer transmission unit 31A through the interface 23. When the offer receiving unit 32B receives the information indicating the counteroffer, it may receive information indicating both the agreed partial offer and the non-agreed partial offer, or may receive information indicating only the non-agreed partial offer.

The offer acceptance determination unit 33B determines, based on the information input by the negotiator B, whether or not to accept (i.e., agree on) the offer received by the offer receiving unit 32B. In this case, the processor 11 functions as the offer acceptance determination unit 33B by controlling the terminal device 2B. For example, under the control of the processor 11, the terminal device 2B displays the offer from the negotiator A based on the information received by the offer receiving unit 32B and receives a user input that specifies whether or not to agree on the entire offer, whether or not to agree on each partial offer, and/or whether or not to suspend the negotiations. The terminal device 2B transmits the received input information to the platform providing device 1, and the processor 11 determines whether or not to accept (i.e., agree on) the offer based on the input information received from the terminal device 2B. In this case, the terminal device 2B may display both the agreed partial offer and the non-agreed partial offer, or 30 may display only the non-agreed partial offer. In the later case, as described below, the terminal device 2B may accept a selection of whether the agreed partial offers should be hidden in a folded state or should be display in an unfolded state.

Upon determining that there is an agreed partial offer, the offer acceptance determination unit 33B adds partial agreement information indicating the agreement of the agreed partial offer 35 to the negotiation information stored in the negotiation information storage unit 121. Instead of generating and storing the partial agreement information, the offer acceptance determination unit 33B may store information indirectly indicating that the partial offer has been agreed on in the negotiation information storage unit 121. The process of storing the information in the negotiation information storage unit 121 is executed based on the input information received by the processor 11 from the terminal device 2B.

Upon determining that there is an agreement on the entire offer, the the offer acceptance determination unit 33B supplies the information indicating the agreed offer (i.e., information indicating the offer received by the offer receiving unit 32B) to the negotiation result display unit 34B.

Upon determining that there is no agreement on the entire offer and that there is an input specifying the suspension of negotiations, the offer acceptance determination unit 33B determines that the negotiations should be suspended and supplies the negotiation result display unit 34B with information indicating both the agreed partial offers and the non-agreed partial offers at the present time. The offer acceptance determination unit 33B may supply the above-mentioned information supplied to the negotiation result display unit 34B to the negotiation result display unit 34A.

Upon determining that there is no agreement on the entire offer and there is no input specifying the suspension of the negotiations, the offer acceptance determination unit 33B supplies the determination result for each partial offer to the offer generation/update unit 30B. The determination result for each partial offer may include information indicating both agreed and non-agreed partial offers, or may include information only indicating non-agreed partial offers.

The offer generation/update unit 30B generates and updates the offer. In this case, the processor 11 functions as the offer generation/update unit 30B by controlling the terminal device 2B. For example, upon receiving the determination result of each partial offer from the offer acceptance determination unit 33B, the offer generation/update unit 30B generates a counteroffer based on the information inputted by the negotiator B. In this instance, the terminal device 2B receives the input regarding an alternative proposal for the non-agreed partial offer and transmits the received input information to the platform providing device 1. Then, the processor 11 generates a counteroffer in which the contents of the agreed partial offers remain unchanged from the last offer and the contents of the non-agreed partial offers have changed based on the input information. The offer generation/update unit 30B may generate a new offer based on the input information received at any timing.

The offer transmission unit 31B supplies information indicating the offer generated or updated by the offer generation/update unit 30B to the offer receiving unit 32A. For example, the processor 11 functions as an offer transmission unit 31B. When transmitting information indicating a counteroffer, the offer transmission unit 31B may transmit information indicating both the agreed partial offers and the non-agreed partial offers, or may transmit information indicating only the non-agreed partial offers.

The negotiation result display unit 34B displays on the terminal device 2B the negotiation result based on the information received from the offer acceptance determination unit 33B. In this instance, the processor 11 functions as the negotiation result display unit 34B to generate display information based on the information received from the offer acceptance determination unit 33B and supplies the generated display information to the terminal device 2B. For example, if the offer is agreed as a whole, the negotiation result display unit 34B displays on the terminal device 2B the information on the agreed offer based on the information received from the offer acceptance determination unit 33B. On the other hand, if the offer is not agreed as a whole, the negotiation result display unit 34B displays the information on both the currently-agreed partial offers and the currently-non-agreed partial offers on the terminal device 2B. Once the offer acceptance determination unit 33A determines that the negotiations should be suspended, the negotiation result display unit 34B may display the negotiation result based on the information received from the offer acceptance determination unit 33 A or the like on the terminal device 2B.

The respective components of the offer generation/update unit 30A, the offer transmission unit 31A, the offer acceptance determination unit 33A, the negotiation result display unit 34A, the offer generation/update unit 30B, the offer transmission unit 31B, the offer acceptance determination unit 33B, and the negotiation result display unit 34B described in FIG.

20) 4 can be realized, for example, by the processor 11 executing a program. The necessary programs may be recorded on any non-volatile storage medium and installed as necessary to realize each component. It should be noted that at least a part of these components may be implemented by any combination of hardware, firmware, and software, or the like, without being limited to being implemented by software based on a program. At least some of these components may also be implemented using a user programmable integrated circuit such as a FPGA (Field-Programmable 25 Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each 30 component may be implemented by various hardware. The above is also true for other example embodiments described later. Furthermore, each of these components may be implemented by the cooperation of a plurality of computers, for example, using cloud computing technology.

### (3-2) Display Examples

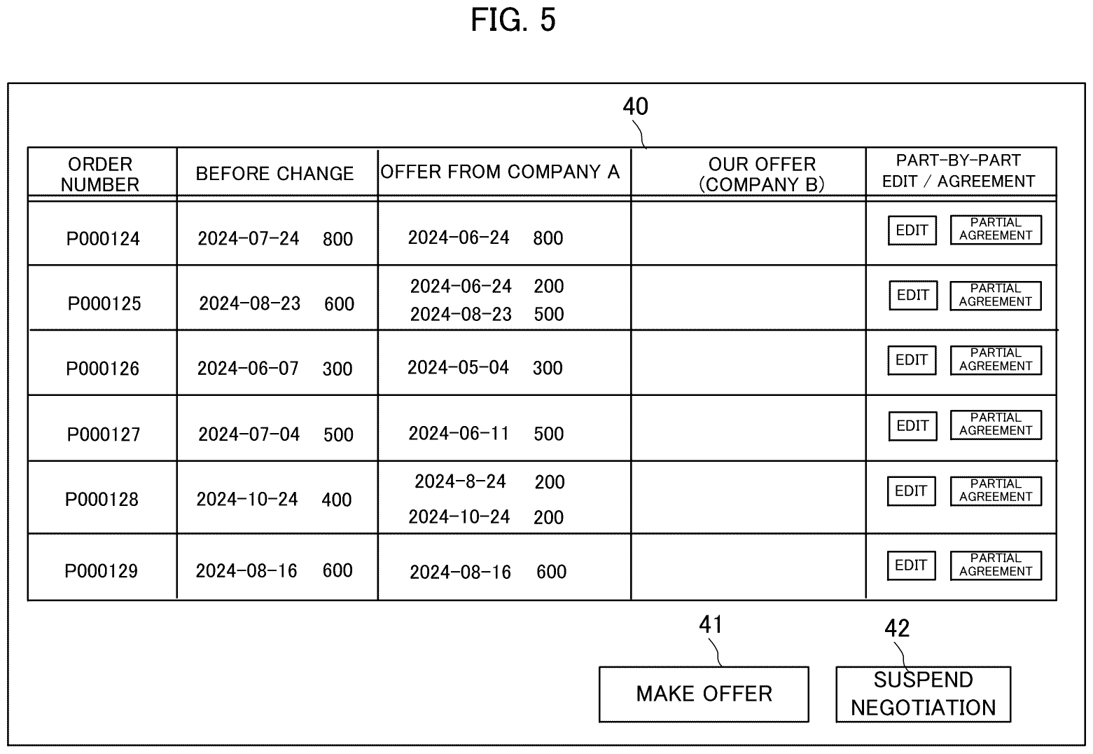

Next, a specific example of information displayed by the terminal device 2B with respect 35 to the offer will be described with reference to FIGS. 5 to 8.

FIG. 5 is an example of an offer edit screen image before input by negotiator B. Here, once the negotiator B (here referred to as “Company B”) inputs information to the effect that the offer generated or updated by the negotiator A (here referred to as “Company A”) is not acceptable, the offer edit screen image for generating a counteroffer is displayed. The platform providing device 1 generates the display information based on the offer generated or updated by the negotiator A and transmits the display information to the terminal device 2B, thereby causing the terminal device 2B to display the offer edit screen image shown in FIG. 5 based on the display information. The process related to the offer edit screen image shown in FIG. 5 is executed by the offer generation/update unit 30B and the offer acceptance determination unit 33B.

The platform providing device 1 provides, on the offer edit screen image shown in FIG. 5, an offer management table 40 having records for respective order numbers, an offer determination button 41 indicating “MAKE OFFER”, and a negotiation suspend button 42 indicating “SUSPEND NEGOTIATION”.

The offer management table 40 has records of orders for respective order numbers, and has items “ORDER NUMBER”, “BEFORE CHANGE”, “OFFER FROM COMPANY A”, “OUR OFFER (COMPANY B)”, and “PART-BY-PART EDIT/AGREEMENT”. The item “ORDER NUMBER” indicates the order number corresponding to each record. In addition to the order number, the identification information of the products corresponding to the order number (including product names and the like) may be further displayed therein. The item “BEFORE CHANGE” indicates the terms and conditions of the order number before the negotiator A proposes the offer. The item “OFFER FROM COMPANY A” indicates the offer from the negotiator A for each corresponding order number. Here, in the field of the item “OFFER FROM COMPANY A”, as an example, the due date (year-month-day) and quantity of products for each order number are displayed as terms and conditions proposed by the negotiator A. Not only the due date (delivery date) and the quantity but also any terms and conditions such as price and transportation means may be further displayed.

The item “OUR OFFER (COMPANY B)” indicates counteroffers for the offers described in the item “OFFER FROM COMPANY A” for respective order numbers. FIG. 5 shows the initial state before input by the negotiator B and therefore no input has yet been made to the item “OUR OFFER (COMPANY B)”.

In the item “PART-BY-PART EDIT/AGREEMENT”, for each order number, there are provided an edit button for editing (inputting) a counteroffer and a partial agreement button for declaring the intention of an agreement. A record for each order number corresponds to a partial offer, and a partial agreement is possible for each record. The edit button and partial agreement button are graphical user interfaces (GUI: Graphical User Interface), and may be realized by any manner without limitation to the shown example.

In some embodiments, the offer management table 40 may include a record of a new order. In this case, the item “BEFORE CHANGE” in the record of the new order is blank.

The offer determination button 41 is a button for deciding to notify the counterpart negotiator (the negotiator A in this case) of the proposed contents displayed in the item “OUR OFFER (COMPANY B)” in the offer management table 40 as a counteroffer. The negotiation suspend button 42 is a button for deciding to suspend the negotiations.

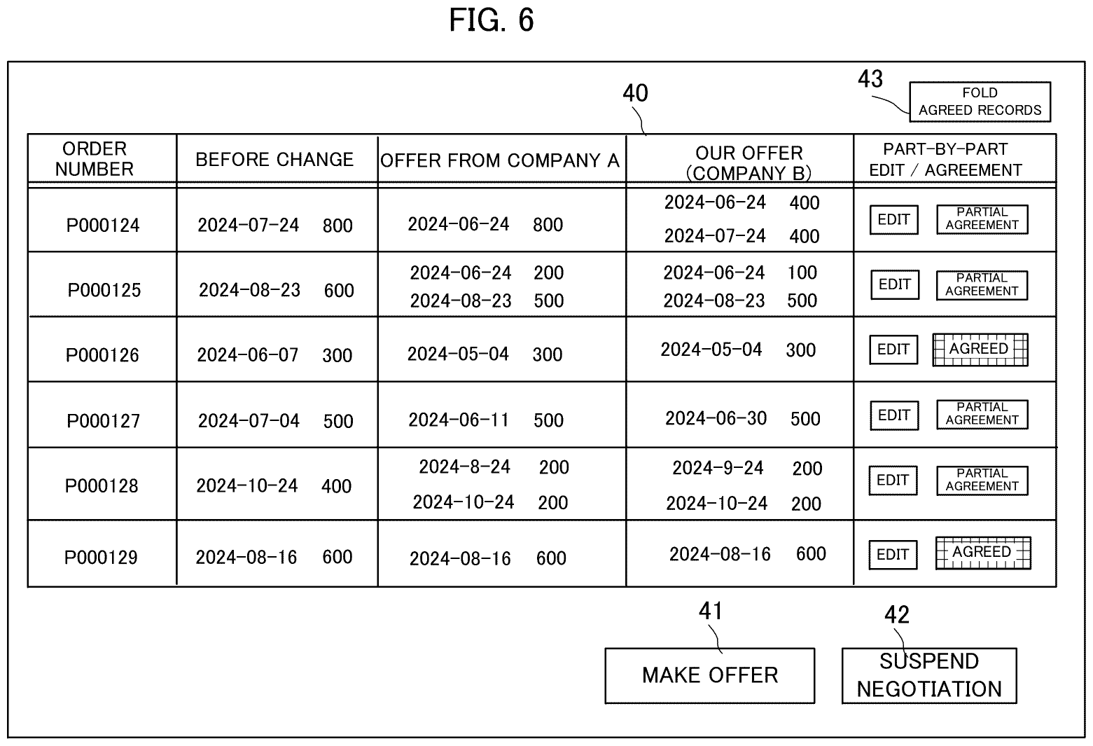

FIG. 6 is an example of an offer edit screen image after the input from the negotiator B. In FIG. 6, the offer edit screen image after the partial agreement for each order number or the input relating to the counteroffer is made by selecting the partial agreement button and selecting the edit button displayed in the item “PART-BY-PART EDIT/AGREEMENT” or the like is shown.

In the example shown in FIG. 6, for each record of the order numbers “P000126” and “P000129”, the indication of the partial agreement button has been changed from “PARTIAL AGREEMENT” to “AGREED” by the fact that the partial agreement button provided in the field of the corresponding item “PART-BY-PART EDIT/AGREEMENT” has been selected on the offer edit screen image. In these records, the same contents as the offer displayed in item “OFFER FROM COMPANY A” is displayed in item “OUR OFFER (COMPANY B)”. For example, in the record of the order number “P000126”, the due date displayed in the item “OFFER FROM COMPANY A” and in the item “OUR OFFER (COMPANY B)” are all on May 4, 2024, and the quantity is 300.

In some embodiments, if the partial agreement button labeled as “AGREED” is selected, the platform providing device 1 may return the selected state of the partial agreement button to the initial state (i.e., the non-selected state) labeled as “PARTIAL AGREEMENT” to cancel the partial agreement. That is, for a record in which the partial agreement has been made, the platform providing device I may accept the cancellation of the partial agreement and returns it to a condition in which the partial agreement has not been made. In this case, the platform providing device 1 deletes the information (e.g., partial agreement information) regarding the canceled partial agreement from the negotiation information stored in the negotiation information storage unit 121. The platform providing device 1 also accepts the input of a counteroffer for the record on which the partial agreement has been cancelled.

In records for which the partial agreement buttons are not selected, counteroffers entered after the selection of the edit buttons provided in the fields of the corresponding item “PART-BY-PART EDIT/AGREEMENT” are displayed in the fields of the item “OUR OFFER (COMPANY B)”. For example, in the record of the order number “P000124”, the offer from the negotiator A shown in the item “OFFER FROM COMPANY A” is 800 on Jun. 24, 2024, whereas the counteroffer from the negotiator B shown in the item “OUR OFFER (COMPANY B)” is 400 on Jun. 24, 2024 and 400 on Jul. 24, 2024.

Further, in the example shown in FIG. 6, due to the existence of the agreed records, a fold button 43 labeled as “FOLD AGREED RECORDS” is provided. The fold button 43 is a button for specifying the switch to the display with the agreed records folded, and the platform providing device 1 changes the display of the offer management table 40 to fold the agreed records and hide their details upon detecting that the fold button 43 has been selected.

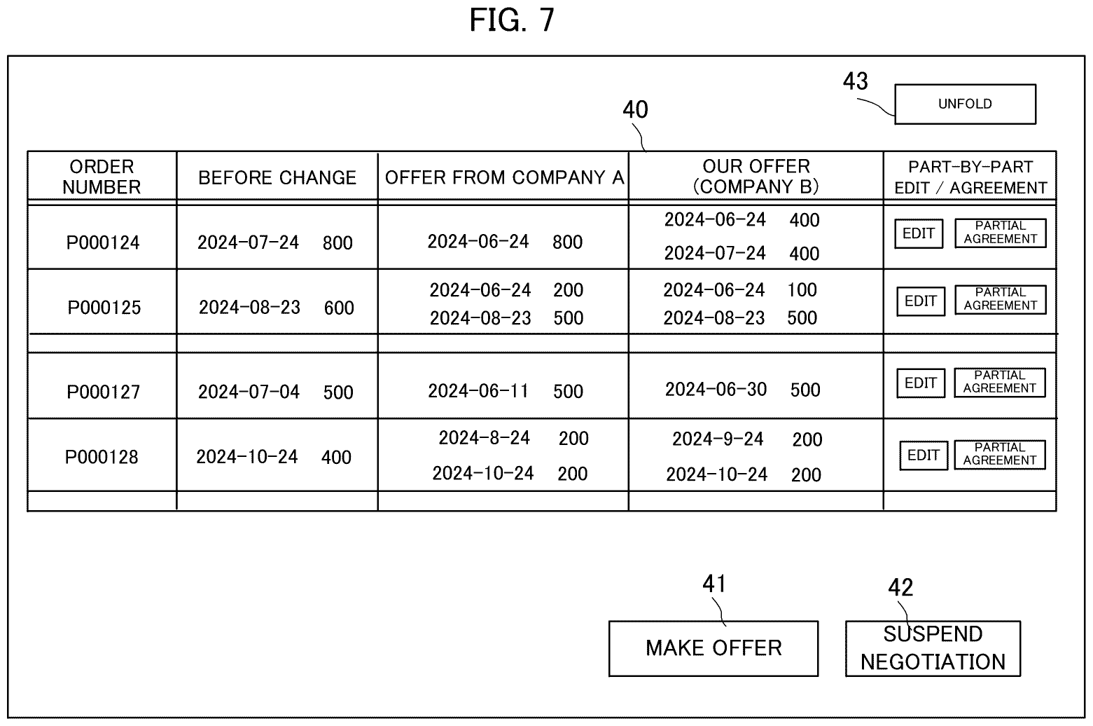

FIG. 7 is an example of the offer edit screen image after the fold button 43 is selected. As shown in FIG. 7, once the fold button 43 is selected, the platform providing device 1 controls the display of the offer-management table 40 so that only the records of the non-agreed order numbers are visible by folding the records of the agreed order numbers “P000126” and “P000129”. In addition, the fold button 43 is denoted as “UNFOLD” once the display to fold the records is designated, and the platform providing device 1 cancels the display to fold the records upon detecting that the fold button 43 denoted as “UNFOLD” is selected. In other words, the platform providing device 1 re-displays the records of the agreed order numbers “P000126” and “P000129”.

As described above, the platform providing device 1 folds the agreed record to hide the details, and displays only the details of the non-agreed (that is, the negotiation target) records. It enables the negotiator B as the user to suitably recognize the target records of negotiations. The fold button 43 is an exemplary graphical user interface for switching to the display

to fold the records as described above, and the platform providing device 1 may accept instructions to switch to the display to fold the records by any GUI. For example, the platform providing device 1 may switch to the display to fold the records upon detecting that a predetermined mark provided in each agreed record has been selected. It is also noted that any button such as a partial agreement button and the offer management table 40 is not limited to the illustrated embodiment, but may be represented by any display embodiment.

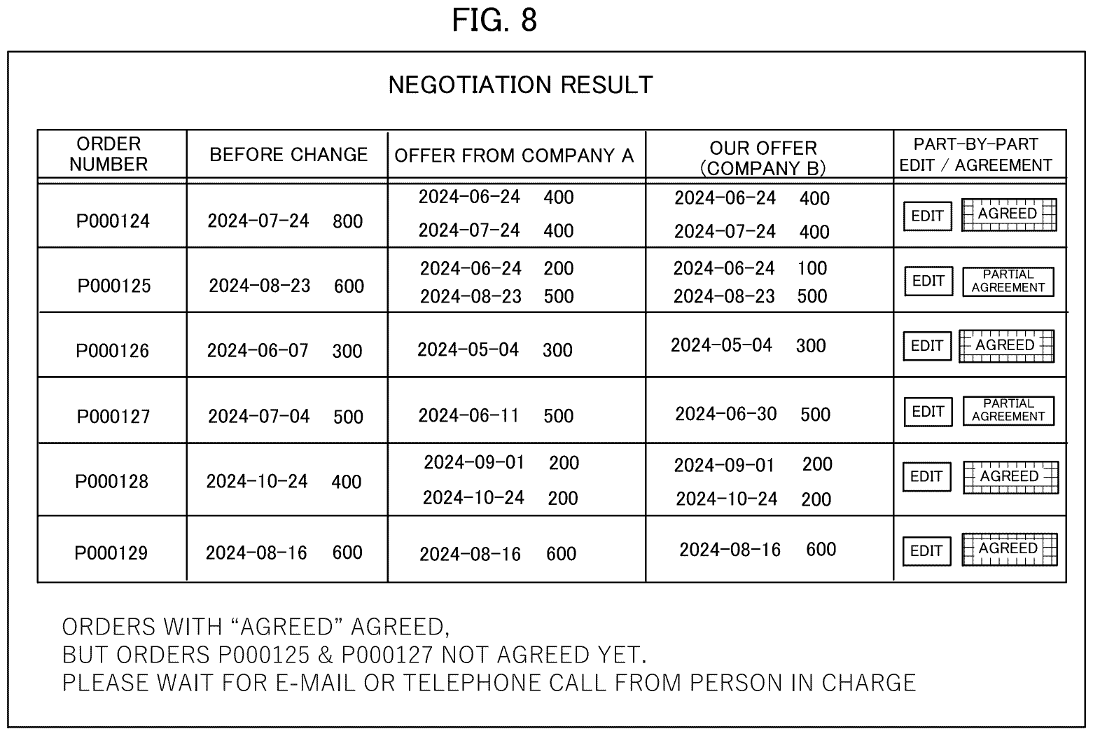

FIG. 8 shows the negotiation result screen image displayed once the negotiation suspend button 42 is selected. In the example shown in FIG. 8, the negotiator A and the negotiator B alternately presented the offers, resulting in an agreement for the order numbers “P000124,” “P000126,” “P000128,” and “P000129,” but not for the order numbers “P000125” and “P000127”. Accordingly, in this case, the platform providing device 1 makes an announcement notifying the negotiating entity B of the text indicating “ORDERS WITH “AGREED” AGREED, BUT ORDERS P000125 & P000127 NOT AGREED YET. PLEASE WAIT FOR E-MAIL OR TELEPHONE CALL FROM PERSON IN CHARGE” on the offer edit screen image. Thus, the platform providing device 1 displays the negotiation result screen image on the terminal device 2B when the negotiation is suspended, so that the negotiator B can clearly recognize the negotiation result. The platform providing device 1 may display the negotiation result screen image shown in FIG. 8 on the terminal device 2A.

### (3-3) Processing Flow

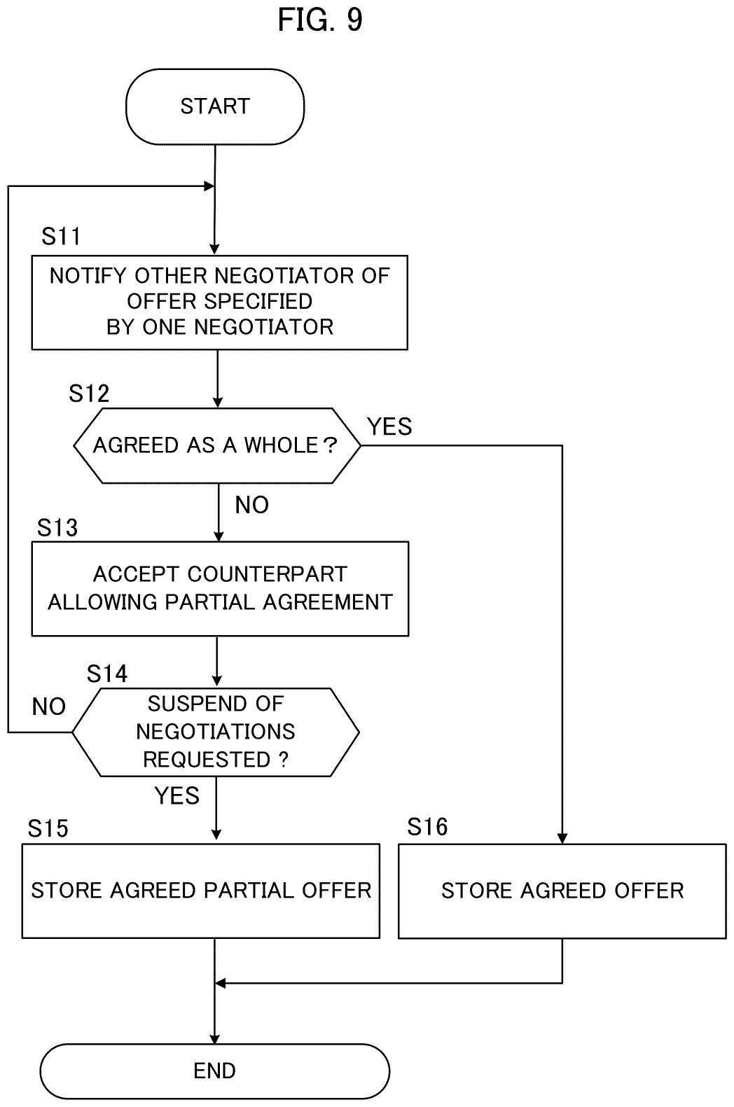

FIG. 9 is an example of the flowchart that is executed by the platform providing device 1 based on input information supplied from the terminal device 2A and the terminal device 2B. Here, the detailed explanation of the process related to the negotiation AI is omitted.

First, the platform providing device 1 notifies the other negotiator of the offer specified by one negotiator (step S11). In this case, if the other negotiator makes manual-based negotiations, the platform providing device 1 performs control to display information indicating the offer specified by the one negotiator on the terminal device 2 used by the other negotiator. On the other hand, if the other negotiator performs the automated negotiations by the negotiation AI, the platform providing device 1 enters the information indicating the offer to the negotiation AI so that the negotiation AI can make the acceptance determination of the offer.

Next, the platform providing device 1 determines whether or not there is an agreement on the entire offer (step S12). For example, if the other negotiator makes manual-based negotiations, the platform providing device 1 determines that there is an agreement on the entire offer upon receiving input information indicating that the other negotiator agrees on the offer specified by the one negotiator from the terminal device 2. On the other hand, if the other negotiator makes automated negotiations by the negotiation AI, the platform-providing device 1 determines that there is an agreement on the entire offer upon receiving a notification from the negotiation AI that the negotiation AI agrees on the entire offer.

Then, upon determining that there is an agreement on the entire offer (step S12; Yes), the platform providing device 1 stores the offer as the agreed offer between the two negotiators (step S16). In this case, for example, the platform providing device 1 stores information indicating the agreed offer in the negotiation information storage unit 121 in association with the agreed date and time information or the like. On the other hand, upon determining that there is no agreement on the entire offer (step S12; No), the platform providing device 1 receives a counteroffer by the other negotiator while accepting partial agreements on partial offers (step S13).

Then, the platform providing device 1 determines whether or not there is a request for suspending the negotiations from any of the negotiators (step S14). For example, if the platform providing device 1 receives the input information instructing to suspend the negotiations from the terminal device 2, or if the negotiation AI determines that the negotiations should be suspended, the platform providing device 1 determines that there is a request for suspending the negotiations. Upon determining that there is a request for suspending the negotiations (step S14; Yes), the platform providing device 1 stores the partially agreed parts of the offer as the agreed partial offers.

For example, the platform providing device 1 stores partial agreement information indicating the agreed partial offers in the negotiation information storage unit 121 in association with the agreed date and time information or the like. Instead of storing the partial agreement information, or in addition to this, the platform providing device 1 may store the history of offers proposed by the negotiators in the negotiation information storage unit 121.

Upon determining that there is no request for suspending the negotiations from any of the negotiators (step S14; No), the platform providing device 1 proceeds back to the process at step S11. In this case, at step S11, the negotiator which specified the counteroffer at the immediately preceding step S13 is regarded as the “one negotiator”, and the counterpart negotiator is regarded as the “other negotiator”.

### (4) Modifications

Next, a description will be given of modifications applicable to the embodiment described above. The following modifications may be applied in any combination.

### First Modification

Instead of making manual-based negotiations, the negotiator B may perform automated negotiations using a negotiation AI.

In this instance, the offer generation/update unit 30B and the offer acceptance determination unit 33B shown in FIG. 4 perform acceptance determination, generation, and update of the offer by the negotiation AI instead of performing acceptance determination, generation, and update of the offer based on the input information received from the terminal device 2B. In this instance, the process executed by the offer generation/update unit 30B and the offer acceptance determination unit 33B is the same as the process performed by the offer generation/update unit 30A and the offer acceptance determination unit 33A described with reference to FIG. 4.

Even in this case, by allowing a partial agreement on an offer, it is possible to suitably reduce the burden of the next negotiations even when the negotiations are suspended.

The negotiator A may conduct manual-based negotiations instead of conducting automated negotiations using a negotiation AI. In this instance, the offer generation/update unit 30A and the offer acceptance determination unit 33A shown in FIG. 4 perform acceptance determination, generation, and update of the offer based on the input information received from 30 the terminal device 2A instead of performing acceptance determination of the offer and generation/update of the offer by the negotiation AI. In this instance, the platform providing device 1 may display the offer edit screen images as shown in FIGS. 5 to 7 on the terminal device 2A and accept inputs related to acceptance of the offer or generation/update of the offer.

### Second Modification

The negotiation AI may be executed by the terminal device 2A, instead of being executed by the platform providing device 1.

In this case, the terminal device 2A stores in the memory 22 the model information in place of the model information storage unit 122, and the processor 21 of the terminal device 2A executes the negotiation AI by referring to the model information. Then, in the same way as in the above-described example embodiment, the negotiation AI determines whether or not an agreement is made for each partial offer of the offer based on information indicating the offer received from the platform providing device 1 or the like, or generates a counteroffer regarding the non-agreed partial offers. Also in this modification, it is possible to suitably realize the automated negotiations for the negotiator A.

### Third Modification

The functions of the platform providing device 1 may be incorporated in the terminal device 2.2

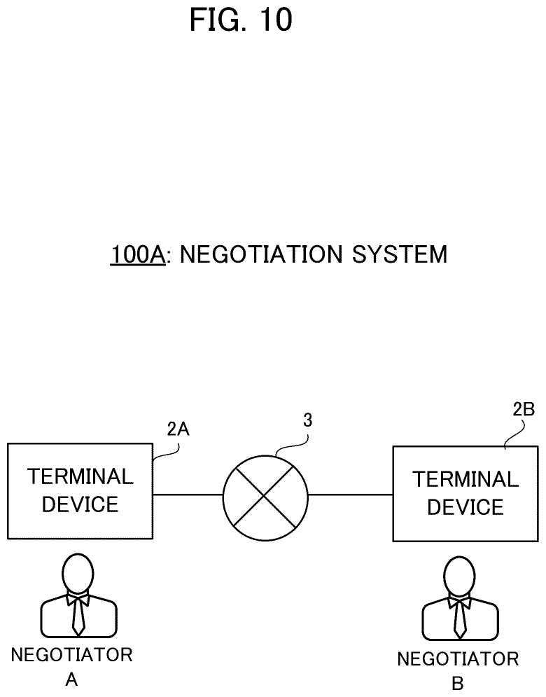

FIG. 10 shows a configuration of a negotiation system 100A. The negotiation system 100A includes a terminal device 2A used by the negotiator A and a terminal device 2B used by the negotiator B. The terminal device 2A and the terminal device 2B performs data communication with each other via the network 3. Then, at least one of the terminal device 2A and/or the terminal device 2B executes the process performed by the platform providing device 1 in FIG. 1 to realize a negotiation platform.

As shown in FIG. 10, even in a mode in which the terminal devices 2 used for negotiations performs data communication with each other, the terminal devices 2 can exchange information necessary for the negotiations to suitably execute the processes related to the notification and acceptance (including a partial agreement) of the offer.

### Second Example Embodiment

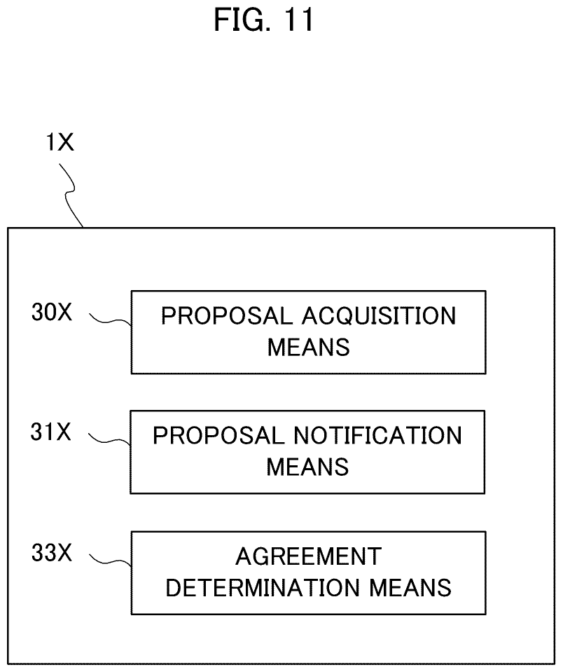

FIG. 11 is a functional block diagram of the agreement determination device 1X. The agreement determination device 1X mainly includes a proposal acquisition means 30X, a proposal notification means 31X, and an agreement determination means 33X. The agreement determination device 1X may be configured by a plurality of devices. Examples of the agreement determination device 1X include the platform providing device 1 in FIG. 1 and the terminal device 2A or/and terminal device 2B in FIG. 10.

The proposal acquisition means 30X is configured to acquire a divisible proposal provided by a first negotiator. Examples of the proposal acquisition means 30X include the offer generation/update unit 30A and the offer generation/update unit 30B in the first example embodiment.

The proposal notification means 31X is configured to notify a second negotiator, which conducts negotiations with the first negotiator, of the proposal. Examples of the proposal notification means 31X include the offer transmission unit 31A or the offer transmission unit 31B.

The agreement determination means 33X is configured to determine whether or not the second negotiator makes a partial agreement on the proposal. Examples of the agreement determination means 33X include the offer acceptance determination unit 33A and the offer acceptance determination unit 33B.

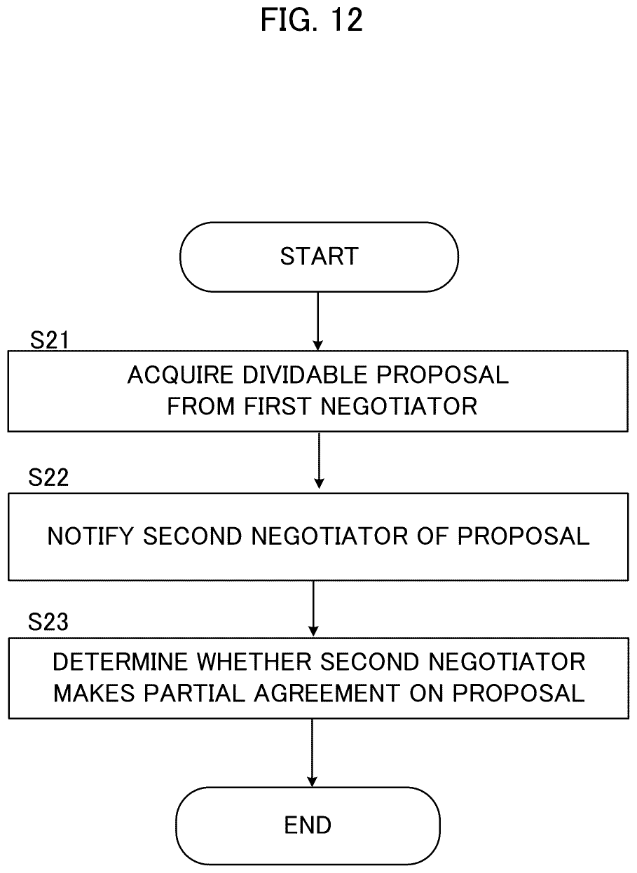

FIG. 12 is an example of a flowchart executed by the agreement determination device 1X. The proposal acquisition means 30X acquires a divisible proposal provided by a first negotiator (step S21). The proposal notification means 31X notifies a second negotiator, which conducts negotiations with the first negotiator, of the proposal (step S22). The agreement determination means 33X determines whether or not the second negotiator makes a partial agreement on the proposal (step S23).

The agreement determination device 1X according to the second example embodiment determines the presence or absence of an agreement on each part of the proposal, which allows for partial agreement on the proposal and reduction of the burden of the next negotiations.

In addition, some or all of the above-described example embodiments (including modifications, the same shall apply hereinafter) may also be described as follows, but are not limited to the following. In addition, some or all of the configurations described in Supplementary Notes 2 to 8 which are dependent on Supplementary Note 1 may be dependent on Supplementary Notes 9 and 10 by the same dependence as Supplementary Notes 2 to 8.

20) Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

An agreement determination device comprising: a proposal acquisition means configured to acquire a divisible proposal provided by a first negotiator;

a proposal notification means configured to notify a second negotiator, which conducts negotiations with the first negotiator, of the proposal; and an agreement determination means configured to determine whether or not the second negotiator makes a partial agreement on the proposal.

### [Supplementary Note 2]

The agreement determination device according to Supplementary Note 1,
wherein the proposal notification means is configured to
   accept an input to specify an agreement for each part of the proposal, while displaying the proposal on a terminal device usable by the second negotiator for the negotiations.

### [Supplementary Note 3]

The agreement determination device according to Supplementary Note 1,
wherein the the proposal notification means is configured to
   accept an input to cancel an agreed part of the proposal, while displaying the proposal on a terminal device usable by the second negotiator for the negotiations.

### [Supplementary Note 4]

The agreement determination device according to Supplementary Note 1,
wherein the proposal notification means is configured to
   hide a detail of an agreed part of the proposal, while displaying the proposal on a terminal device usable by the second negotiator for the negotiations.

### [Supplementary Note 5]

The agreement determination device according to Supplementary Note 1,
wherein the proposal notification means is configured to accept an input to specify whether or not to hide a detail of an agreed part of the proposal, while displaying the proposal on a terminal device usable by the second negotiator for the negotiations.

### [Supplementary Note 6]

The agreement determination device according to Supplementary Note 1, further comprising
a counter proposal acquisition means configured to acquire a counter proposal regarding a non-agreed part, which is not an agreed part, of the proposal.

### [Supplementary Note 7]

The agreement determination device according to Supplementary Note 6, further comprising
a counter proposal notification means configured to notify the first negotiator of the counter proposal regarding the non-agreed part.

### [Supplementary Note 8]

The agreement determination device according to Supplementary Note 1, further comprising
a negotiation result display means configured to, once the negotiations have been suspended, execute the instructions to cause at least one of a first terminal device usable by the first negotiator for the negotiations and/or a second terminal device usable by the second negotiator to display an agreed part of the proposal and a non-agreed part, which is not the agreed part, of the proposal.

### [Supplementary Note 9]

An agreement determination method executed by a computer, comprising:
acquiring a divisible proposal provided by a first negotiator;
notifying a second negotiator, which conducts negotiations with the first negotiator, of the proposal; and
determining whether or not the second negotiator makes a partial agreement on the proposal.

### [Supplementary Note 10]

A program executed by a computer, the program causing the computer to:
acquire a divisible proposal provided by a first negotiator;
notify a second negotiator, which conducts negotiations with the first negotiator, of the proposal; and
determine whether or not the second negotiator makes a partial agreement on the proposal.

### [Supplementary Note 11]

A storage medium storing a program according to Supplementary Note 10.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Platform providing device
1X Agreement determination device
(2A, 2B) Terminal device
3 Network
4 Storage device
100, 100A Negotiation system

What is claimed is:

1. An agreement determination device comprising:
at least one memory configured to store instructions; and
at least one processor configured to execute the instructions to:
acquire a divisible proposal provided by a first negotiator;
notify a second negotiator, which conducts negotiations with the first negotiator, of the proposal; and
determine whether or not the second negotiator makes a partial agreement on the proposal.

2. The agreement determination device according to claim 1,
wherein the at least one processor is configured to execute the instructions to
accept an input to specify an agreement for each part of the proposal, while displaying the proposal on a terminal device usable by the second negotiator for the negotiations.

3. The agreement determination device according to claim 1,
wherein the at least one processor is configured to execute the instructions to
accept an input to cancel an agreed part of the proposal, while displaying the proposal on a terminal device usable by the second negotiator for the negotiations.

4. The agreement determination device according to claim 1,
wherein the at least one processor is configured to execute the instructions to
hide a detail of an agreed part of the proposal, while displaying the proposal on a terminal device usable by the second negotiator for the negotiations.

5. The agreement determination device according to claim 1,
wherein the at least one processor is configured to execute the instructions to
accept an input to specify whether or not to hide a detail of an agreed part of the proposal, while displaying the proposal on a terminal device usable by the second negotiator for the negotiations.

6. The agreement determination device according to claim 1,
wherein the at least one processor is configured to execute the instructions to acquire a counter proposal regarding a non-agreed part, which is not an agreed part, of the proposal.

7. The agreement determination device according to claim 6,
wherein the at least one processor is configured to execute the instructions to notify the first negotiator of the counter proposal regarding the non-agreed part.

8. The agreement determination device according to claim 1,
wherein once the negotiations have been suspended, the at least one processor is configured to execute the instructions to cause at least one of a first terminal device usable by the first negotiator for the negotiations and/or a second terminal device usable by the second negotiator to display an agreed part of the proposal and a non-agreed part, which is not the agreed part, of the proposal.

9. An agreement determination method executed by a computer, comprising:
acquiring a divisible proposal provided by a first negotiator;
notifying a second negotiator, which conducts negotiations with the first negotiator, of the proposal; and
determining whether or not the second negotiator makes a partial agreement on the proposal.

10. A non-transitory computer readable storage medium storing a program executed by a computer, the program causing the computer to:
acquire a divisible proposal provided by a first negotiator;
notify a second negotiator, which conducts negotiations with the first negotiator, of the proposal; and
determine whether or not the second negotiator makes a partial agreement on the proposal.
